(19) United States
(12) Patent Application Publication
(10) Pub. No.: US 2007/0110629 A1
(43) Pub. Date: May 17, 2007

(54) Sampling device for a microreaction system

(76) Inventors: Michael Schmelz, Riedstradt (DE); Gunter Brenner, Griesheim (DE); Thomas Greve, Darmstadt (DE); Hanns Wurziger, Darmstadt (DE); Mirco Arndt, Muhltal (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/563,241

(22) PCT Filed: Jun. 5, 2004
(86) PCT No.: PCT/EP04/06094

§ 371 Date: Jan. 3, 2006

(30) Foreign Application Priority Data
Jul. 4, 2003 (DE) 103 30 299.9

(51) Int. Cl. B01L 3/02

(52) U.S. Cl. 422/100

(57) ABSTRACT

The invention relates to a sampling device (1) for a microreaction system (3), comprising an outlet (4) and a suction line opening (9) which is arranged next to the outlet (4). A depression can be produced in the suction line (9) for the suction of the substances (13) leaving the outlet (4). The outlet (4) is embodied as a capillary and can be positioned in relation to the opening of the suction line (9). The outlet (4) is surrounded by a housing (6) comprising a discharge outlet (14) for the substances (13) leaving the outlet (4), and a through-opening (8) for the suction line (9). Said suction line (9) opens up into a collecting tank (10) that is connected to a vacuum line (12) by means of an electrovalve (1).

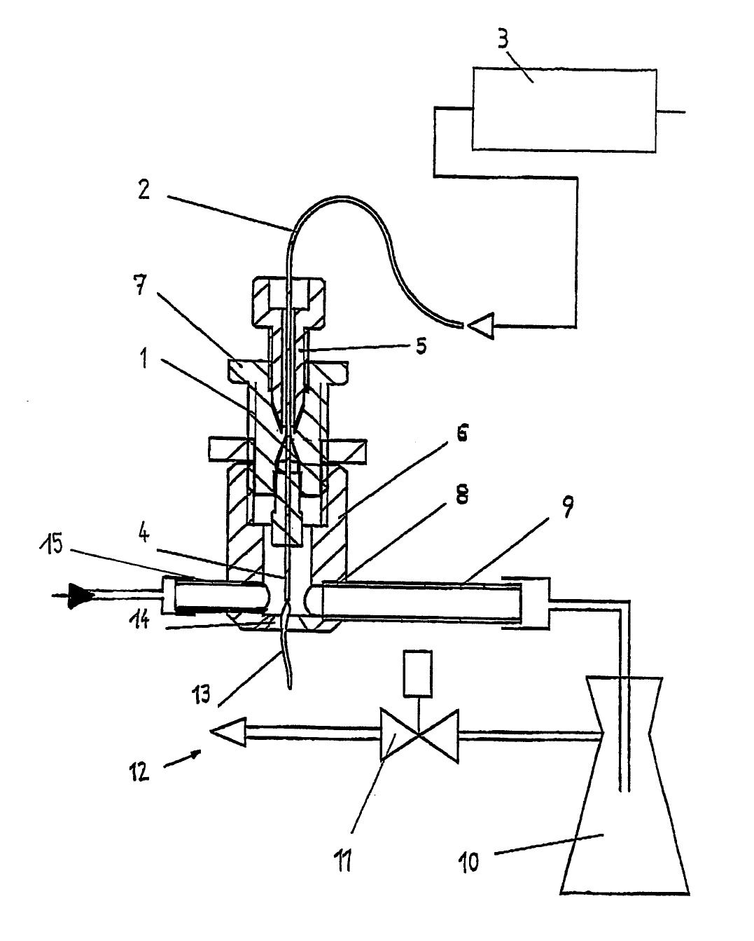

The invention relates to a sampling device for a microreaction system having an exit aperture for substances involved in the reaction.

Constant development and progressive miniaturisation of microreactors and microreaction systems have now enabled chemical reactions to be carried out with minimal use of reagents. In particular when carrying out a large number of test reactions and analyses, the use of miniaturised microreaction systems enables effort and costs to be saved, both with respect to the substance quantities necessary and also the reaction durations required. In addition, the thermal process control is simplified by the reduced mass flows, and safety when carrying out the chemical reactions may be considerably increased.

It is frequently necessary here to take small sample quantities from a continuously operated microreaction system without hindering or stopping the flow of the reagents through the microreaction system or a running chemical reaction. To this end, it is usual to provide an exit aperture which is arranged at a suitable point within the microreaction system and can be controlled via a valve. Depending on the design of the exit aperture and of the valve controlling this exit aperture, cavities are formed which are connected to the microreaction system and in which the chemical reaction proceeding in the microreaction system does not proceed or only proceeds under different, usually uncontrollable conditions. The presence of such cavities, which are referred to as dead spaces, may have an adverse effect on the chemical reaction in the microreaction system and may additionally reduce the validity of an evaluation in which the sample quantity taken was taken exclusively or partly from a dead space existing in the region of the exit aperture.

In addition, the use of valves requires complex rinsing operations in order carefully to clean the microreaction system, including the valve connected thereto, after completion of one microreaction and before commencement of a subsequent microreaction in order to prevent contamination of the subsequent microreaction. Leakproof sealing of an exit aperture by means of a valve can likewise only be ensured with considerable design complexity.

The object of the invention is accordingly to design a sampling device in such a way that samples can be taken reliably from a microreaction system, while dead spaces in the region of the exit aperture for sampling are avoided as far as possible and thus impairment of the chemical reaction proceeding in the microreaction system is reduced.

This object is achieved in accordance with the invention in that an aperture a suction line is arranged laterally alongside the exit aperture, where a reduced pressure can be generated in the suction line for aspiration of the substances exiting from the exit aperture. The exit aperture is used here either as exit of the microreaction system for complete exit of the substances involved in the chemical reaction or designed to be sufficiently small at a suitable point within the microreaction system so that a substance quantity exiting continuously at this point does not significantly impair the reaction proceeding in the microreaction system. There is thus no necessity to arrange a valve between the exit aperture and the microreaction system connected thereto, meaning that practicable designs are feasible which manage with only a minimal dead space in the region of the exit aperture, or even none at all.

Whether the substance quantity exiting from the exit aperture at a particular point in time is not used further or alternatively is sent as sample for further evaluation can be controlled by means of the suction line arranged immediately alongside the exit aperture. If an adequate reduced pressure prevails in the suction line, the substance quantity exiting from the exit aperture at a particular point in time is sucked into the suction line. Without a reduced pressure in the suction line, the substance quantity exiting from the exit aperture falls past the suction line without being affected and can be collected below the suction line. Depending on a preferred design or the mixing ratio of substance not used further to substance used as sample for further evaluation, either the substance quantity aspirated in the suction line or the substance quantity below the suction line falling past the latter can be sent for further use.

It is preferably provided here that a housing having an outlet aperture for substances exiting from the exit aperture and having a passage aperture for the suction line is arranged around the exit aperture. The housing firstly protects the region around the exit aperture against undesired uncontrollable environmental influences and secondly allows precise and reproducible arrangement of the suction line relative to the exit aperture by simple means. The closer the aperture of the suction line can be arranged relative to the exit aperture without exiting substances coming into direct contact with the suction line, the lower the minimum reduced pressure required within the suction line in order to ensure complete aspiration of the substance quantity exiting from the exit aperture.

According to one embodiment of the inventive idea, it is provided that the arrangement of the aperture of the suction line relative to the exit aperture can be modified. In this way, at a prespecified reduced pressure in the suction line, the suction effect this causes in the region of the exit aperture can be adjusted in order to take into account potentially different properties of the substances used and reaction products, for example different viscosities or volatilities.

According to an embodiment of the inventive idea, it is provided that the suction line runs into a collecting vessel, which is connected via a valve to a vacuum line. Thus, for example in the case of a continuous reduced pressure, the microreaction system can be completely emptied via the exit aperture, with the substance quantities exiting being rinsed into the collecting vessel via the suction lines. After complete emptying of the microreaction system, if necessary with subsequent rinsing with cleaning agents, all substances involved in the reaction are located in the collecting vessel, for example a commercially available wash bottle. This collecting vessel can simply be separated and removed from the sampling device in order to facilitate disposal or further use of the reaction products.

The reduced pressure in the collecting vessel and the suction line running into the collecting vessel can be controlled in a simple manner via the valve arranged in the vacuum line to the collecting vessel. The vacuum line leads either directly to a vacuum pump or is part of a vacuum system having a multiplicity of connections, as installed, in particular, in larger chemical laboratories. The collecting vessel and the suction line have a sufficiently small internal volume in order to be able to build up or compensate for a sufficient reduced pressure for aspiration with the minimum of delay, depending on the valve control.

In this advantageous mode of operation of continuous aspiration of the substance quantities exiting from the exit aperture, a sample can be taken at any desired point in time by interrupting the suction operation by brief closure of the valve, and the substance quantity exiting from the exit aperture falls past the suction line into a sample container arranged below the exit aperture. The sample quantity to be taken can be specified via the time within which no aspiration of the exiting substances occurs.

It is preferably provided that the exit aperture is designed in the form of a capillary. A capillary facilitates firstly accurate metering even of small substance quantities during exit from the microreaction system and secondly substantially prevents the reactions proceeding in the microreaction system from being influenced by the varying pressure conditions in the immediate vicinity of the exit aperture. The internal diameter of the capillary here is advantageously selected to be sufficiently small in order to ensure complete aspiration of the exiting substance quantities and on the other hand are selected to be sufficiently large in order to avoid putting continuous exit of the substances at risk due to a greatly increasing differential pressure in the capillary. By means of a suitable capillary, it can be ensured, in particular, that the substance exits from the exit aperture in a fine, free jet.

It is advantageously provided that the sampling device is heatable in the region of the exit aperture. It has been found that ice formation can occur at the exit aperture on use of readily volatile solvents, such as, for example, dichloromethane or ether, owing to the enthalpy of evaporation of the solvent. This undesired impairment during operation can readily be avoided by warming the sampling device in the region of the exit aperture.

According to an embodiment of the inventive idea, it is provided that an electric heating device or heat coupling is provided for the heating. An electric heating device in the form of a controllable heating wire can advantageously be matched to the design of the exit aperture, for example in the form of a capillary, by simple means.

According to an embodiment of the inventive idea, it is provided that a protective-gas atmosphere which displaces the atmospheric moisture can be generated and maintained in the region of the exit aperture. The protective-gas atmosphere can be used instead of or in addition to a heating device in order to prevent undesired ice formation at a cooling exit aperture. In addition, it is possible by means of a protective-gas atmosphere substantially to prevent contamination of the substances exiting from the exit aperture.

It is advantageously provided that an aperture of a compressed-air line is arranged laterally alongside the exit aperture opposite the aperture of the exhaust-air line, where an excess pressure of a gas can be generated in the compressed-air line in order to blow the substances exiting from the exit aperture in the direction of the aperture of the suction line by means of the gas flowing out through the aperture of the compressed-air line. In this way, the exiting substances can be blown, in support of the suction operation, in the direction of the aperture of the suction line by the gas exiting with excess pressure, guaranteeing complete and reliable aspiration of all exiting substances, even under unfavourable conditions or with comparatively low pressure differences from the ambient pressure in the exhaust-air line or compressed-air line.

According to an embodiment of the inventive idea, it is provided that the gas used is a chemically substantially inactive protective gas. Undesired reactions of the gas flowing out with the substances sucked together into the suction line are thus avoided. On use of a protective gas, a protective-gas atmosphere generated in the region of the exit aperture of the substances can also be maintained undisturbed.

Given a corresponding design of the suction system, the substance can be blown from the capillary into the collection tube without a vacuum, only through the pressure of the air or inert gas.

It is preferably provided that the sampling device can be made substantially or completely of chemically resistant materials.

A working example of the invention is described in greater detail below and depicted in the drawing.

The sampling device 1 depicted in the FIGURE is connected via a tube 2 to a microreaction system 3. When the reaction is complete, the entire microreaction system 3 is completely emptied via the sampling device 1. The exit aperture 4 is designed in the form of a capillary.

The tube 2 is detachably connected via a connection piece 5 to the exit aperture 4 in the form of a capillary. In this way, a plurality of microreaction systems 3 with different sampling devices 1 can be used in any desired combination, so that, for example, sampling devices 1 assigned depending on the substances used can be combined with a microreaction systems 3 which is suitable for particular applications, or a microreaction system 3 to be cleaned or a sampling device 1 to be cleaned can simply be exchanged in order to ensure the most continuous operation possible.

The exit aperture 4 designed in the form of a capillary is arranged movably in the interior of a sleeve-shaped housing 6. Both the connection piece 5 of the tube 2 and also the exit aperture 4 in capillary form are secured in a housing lid 7, which engages with the housing 6 via a screw thread and thus facilitates longitudinal movement of the open end of the capillary relative to the housing base 6.

The housing 6 has, adjacent to the capillary-shaped exit aperture 4, a passage aperture 8, through which a suction line 9 projects into the interior of the housing 6. The suction line 9 runs into a wash bottle 10, which is connected via a magnetic valve 11 to a vacuum line 12.

With the magnetic valve 11 opened, a reduced pressure is formed in the wash bottle 10 and the suction line 9, causing substances 13 exiting from the exit aperture 4 to be sucked into the suction line 9 and collected in the wash bottle 10.

In order to take a sample of the reaction products, the magnetic valve 11 is closed and the reduced pressure in the suction line 9 is thereby cancelled for a defined time, with the result that the substance quantity 13 exiting from the exit aperture 4 is not sucked into the suction line 9, but instead exits through an outlet aperture 14 in the base of the housing 6 and can be collected in a sample container (not shown).

Over the duration of the switched-on or switched-off vacuum, the substance quantity 13 aspirated or exiting through the outlet aperture 14 respectively can be metered precisely, so that it is conceivable that the sampling device can also be used as metering system.

An aperture of a compressed-air line 15 is arranged laterally alongside the capillary-shaped exit aperture 4 opposite the aperture of the suction line 9. If the gas located in the compressed-air line is charged with excess pressure, the gas flows out through the aperture of the compressed-air line 15 and blows substances exiting from the exit aperture 4 in the direction of the aperture of the suction line 9. The aspiration of exiting substances into the suction line 9 is supported by a pressurisation generated in the compressed-air line 15 at the same time as the vacuum. The pressurised gas used is advantageously air or an inert gas for directed blowing-away of the exiting substances.

It is also possible, given suitable pressurisation of the substances exiting from the exit aperture 4, also to use the device described as pressure head without significant modifications.

1. Sampling device for a microreaction system having an exit aperture for substances involved in the reaction, characterised in that an aperture of a suction line (9) is arranged laterally alongside the exit aperture (4), where a reduced pressure can be generated in the suction line (9) for aspiration of the substances (13) exiting from the exit aperture (4).

2. Sampling device according to claim 1, characterised in that a housing (6) having an outlet aperture (14) for substances (13) exiting from the exit aperture (4) and having a passage aperture (8) for the suction line (9) is arranged around the exit aperture (4).

3. Sampling device according to claim 1, characterised in that the arrangement of the aperture of the suction line (9) relative to the exit aperture (4) can be modified.

4. Sampling device according to claim 1, characterised in that the suction line (9) runs into a collecting vessel (10), which is connected via a valve (11) to a vacuum line (12).

5. Sampling device according to claim 1, characterised in that the exit aperture (4) is designed in the form of a capillary.

6. Sampling device according to claim 1, characterised in that the sampling device (1) is heatable in the region of the exit aperture (4).

7. Sampling device according to claim 6, characterised in that an electric heating device or heat coupling is provided for the heating.

8. Sampling device according to claim 1, characterised in that a protective-gas atmosphere which displaces the atmospheric moisture can be generated and maintained in the region of the exit aperture (4).

9. Sampling device according to claim 1, characterised in that an aperture of a compressed-air line (15) is arranged laterally alongside the exit aperture (4) opposite the aperture of the exhaust-air line (9), where an excess pressure of a gas can be generated in the compressed-air line (15) in order to blow the substances (13) exiting from the exit aperture (4) in the direction of the aperture of the suction line (9) by means of the gas flowing out through the aperture of the compressed-air line (15).

10. Sampling device according to claim 9, characterised in that the gas used is a chemically substantially inactive protective gas.

11. Sampling device according to claim 1, characterised in that the sampling device (1) can be made substantially or completely of chemically resistant materials.
